(19) United States
(12) Patent Application Publication
(10) Pub. No.: US 2019/0091592 A1
(43) Pub. Date: Mar. 28, 2019

(54) PHYSICAL DEVICE SIMULATING THE APPEARANCE AND MOVEMENT OF A TWO-LEGGED CREATURE

(71) Applicant: Dash Robotics, Inc., Hayward, CA (US)

(72) Inventors: Andrew George GILLIES, Oakland, CA (US); Quillon TSANG, Daly City, CA (US); Dwight SPRINGTHORPE, II, Albany, CA (US); Karan HANDA, San Mateo, CA (US); Autumn TURPIN, Stanford, CA (US); Nicholas Joseph KOHUT, Mountain View, CA (US)

(21) Appl. No.: 16/140,185

(22) Filed: Sep. 24, 2018

Related U.S. Application Data
(60) Provisional application No. 62/562,278, filed on Sep. 22, 2017.

(51) Int. Cl. A63H 11/20; B62D 57/032; B25J 11/00

(52) U.S. Cl. CPC A63H 11/20; A63H 2200/00; B25J 11/003; B62D 57/032

(57) ABSTRACT

A robot with locomotive capability is described here. In some embodiments, the robot has a frontal body connected to a rear body via a middle body. In some embodiments, the frontal body to rotate with respect to the rear body. In some embodiments, a first frontal limb and a second fontal limb are pivotally secured to the frontal body. In some embodiments, a first leg with a first foot is connected to a first side of the rear body. In some embodiments, a second leg with a second foot is connected to a second side of the rear body. In some embodiments, the first frontal limb, the second frontal limb, and either the first foot or the second foot form a triangular alignment encompassing the robot's center of gravity as the first leg and the second leg alternately move between a forward position and a rearward position.

### RELATED APPLICATION

This application claims the benefit of U.S. Provisional Patent Application No. 62/562,278, titled “PHYSICAL DEVICE SIMULATING THE APPEARANCE AND MOVEMENT OF A TWO-LEGGED CREATURE,” which was filed on Sep. 22, 2017 and is hereby incorporated by reference herein its entirety.

### TECHNICAL FIELD

The subject matter disclosed in this application generally relates to robots, and more specifically, to robotic toys, such as a biomimetic children's toy, a remote-controlled “walking” toy, or an autonomous robot.

### BACKGROUND OF THE INVENTION

Some embodiments of the present disclosure describe a robotic toy that simulates the appearance and movement of a two-legged creature. One example of the two-legged creature being simulated by the present invention is a velociraptor. Velociraptors, a species of dinosaurs, are a bipedal carnivore with a long tail and an enlarged sickle-shaped claw on each hindfoot. Velociraptors are known for their ability to maintain their balance while running with two hind legs at a high speed.

Known toy designs for simulating velociraptor-like bipedal motion suffer from many shortcomings. One challenge of creating a robotic toy that simulates the movement of a bipedal creature like a velociraptor is the ability to maintain balance while moving in a bipedal fashion. There are certain designs that adopt complicated mechanisms to mimic the bipedal movement. However, such designs are not ideal for toys. This is because such designs are difficult to assemble, and they are also often very complex and expensive to make. For instance, some of these designs may require multiple sensors and hydraulic systems. There are also designs using wider feet with a flat surface, instead of dinosaur claws, to keep the toy upright and balanced; however, these designs make the toy appear more like a robot and less like a dinosaur, because creatures like velociraptors are generally known to have strong legs and relatively smaller feet with claws.

Accordingly, it is desirable to provide a robotic toy that simulates both the appearance and movement of a two-legged creature such as a velociraptor. It is also desirable for the robotic toy to look and move in a convincing manner just as a two-legged creature would in real life. Moreover, it is desirable for such robotic toy to have safety features and a simple assembly process suitable for toys.

### SUMMARY

In one embodiment, a robot with locomotive capability is provided. The robot has a frontal body, a rear body, a middle body, a first and a second frontal limb, a first and a second leg, and a first and a second foot. The middle body has a first end coupled to the frontal body, a second end that is opposite to the first end of the middle body and coupled to the rear body. The middle body is configured to cause the frontal body to rotate with respect to the rear body. The first frontal limb is pivotally secured to the frontal body and has a first distal end. The second frontal limb is pivotally secured to the frontal body and has a second distal end. The first leg is pivotally secured to a first side of the rear body and has a third distal end. The first foot is pivotally secured to the third distal end. The second leg is pivotally secured to a second side of the rear body and has a fourth distal end, and the second side of the rear body is opposite to the first side of the rear body. The second foot is pivotally secured to the fourth distal end. The first distal end of the first frontal limb, the second distal end of the second frontal limb, and either the first foot or the second foot are configured to support the robot by forming a triangular alignment encompassing a center of mass of the robot as the first leg and the second leg alternately move between a forward position and a rearward position.

In one embodiment, the robot has an appearance of a dinosaur such as a velociraptor. In some embodiments, the frontal limbs of the robot are shaped like a velociraptor's claw and the rear legs are shaped like a velociraptor's legs and feet. In some embodiments, the robot is powered by a motor or a servo motor configured to rotate the legs of the robot, so that the robot can move in a bipedal fashion.

In one embodiment, the robot is designed to maintain balance while going through the bipedal motion. In some embodiments, the robot is configured to move forward or backward one step at the time. In some embodiments, the robot legs are constructed from multiple linkages to promote flexibility and absorb shock. In some embodiments, the robot incorporates multiple safety features such as sliding black plates to prevent accidental finger entrapment.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

These and other capabilities of embodiments of the disclosed subject matter will be more fully understood after a review of the following figures, detailed description, and claims.

It is to be understood that both the foregoing general description and the following detailed description are explanatory only and are not restrictive of the claimed subject matter.

### BRIEF DESCRIPTION OF DRAWINGS

Various objects, features, and advantages of the disclosed subject matter can be more fully appreciated with reference to the following detailed description of the disclosed subject matter when considered in connection with the following drawings, in which like reference numerals identify like elements. While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive. Many of the figures presented herein are black and white representations of images originally created in color.

FIG. 1 illustrates a left-side view of a robot with locomotive capability according to certain embodiments of the present disclosure.

FIG. 2 illustrates a right-side view of a robot with locomotive capability according to certain embodiments of the present disclosure.

FIG. 3 illustrates a left side view of a robot with a rotation middle body according to certain embodiments of the present disclosure.

FIG. 4 illustrates an exploded view of a robot's frontal and rear bodies according to certain embodiments of the present disclosure.

FIG. 5 illustrates an exploded view of a robot with a cavity for housing a motor according to certain embodiments of the present disclosure.

FIGS. 6A and 6B illustrate an exemplary leg linkage mechanism for the robot according to certain embodiments of the present disclosure.

FIG. 7 illustrates exemplary sliding backplates to prevent finger entrapment according to certain embodiments of the present disclosure.

FIG. 8 illustrates a crank attachment with finger entrapment prevention mechanisms according to certain embodiments of the present disclosure.

FIG. 9 illustrates an exploded view of a robot foot according to certain embodiments of the present disclosure.

FIG. 10 illustrates a toe-down position of a robot in motion according to certain embodiments of the present disclosure.

FIGS. 11A-11B illustrate cranks on the opposite of the body having a 180 degree off-phase relationship according to certain embodiments of the present disclosure.

FIGS. 12A-12D illustrate a sequence of movement as the robot legs rotate through a forward and a rearward position according to certain embodiments of the present disclosure.

FIGS. 13A-13C illustrate potential triangular alignment diagrams according to certain embodiments of the present disclosure.

FIG. 14 illustrates a process of maintaining stability while moving in a bipedal fashion according to certain embodiments of the present disclosure.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, apparatuses, and/or methods that are within the scope of the disclosed subject matter.

The following description makes reference to spatial relations in addition to directional orientations, such as views with regard to the figures. However, any terms such as up, down, left, right, top, bottom, front, back, above, below, upper, lower, proximal, distal, and the like are used primarily to differentiate between the views and orientations relative to other building elements or pieces within any particular configuration, or series of views or illustrations, and to help describe the relationship between pieces to the reader.

The present invention is directed to a three-dimensional (3D) robot that can stably move in a bipedal fashion. The robot is configured to simulate the appearance and movement of a creature that primarily moves on two legs. Creatures that move in a bipedal fashion shift their center of gravity constantly. For example, as a human walks or runs, the human's center of gravity shifts from left to right and right to left constantly. Stability in this type of movement takes practice. Developing children often wobble and fall when they try to run because at a higher speed the shift becomes more violent, and thus more difficult to remain stable.

In robotics design, the same challenge exists. Many factors must align for a robot to remain stable while moving in a bipedal fashion. And similar to a developing child, the faster the movement's speed, the more challenging it is for the robot to remain stable. Besides the speed, another challenge is for the robot to stay upright when a misstep happens. Unlike human and animals, a robot's movements are often dictated by certain mechanical constraints such as the circumference of a gear or the speed output of a motor. Therefore, it is more difficult for a robot to adjust to a misstep.

The present invention discloses a novel mechanical configuration that would allow a robot driven by the bipedal movement to maintain its stability while moving at a walking or running pace. In addition, the present invention includes a mechanism that would allow a bipedal-driven robot to adjust its center of gravity when a miss step occurs. The invention can be applied to any suitable toy models, including, for example, robots that jump like kangaroo, robots that move on two wheels with one axle, or robots that move on a single moving ball. While the invention is primarily described in the context of a children's robotic toy, the invention also applies to any other suitable robotic technologies. For example, certain robotic mechanisms disclosed herein can be used for robotic chairs or robotic wagons.

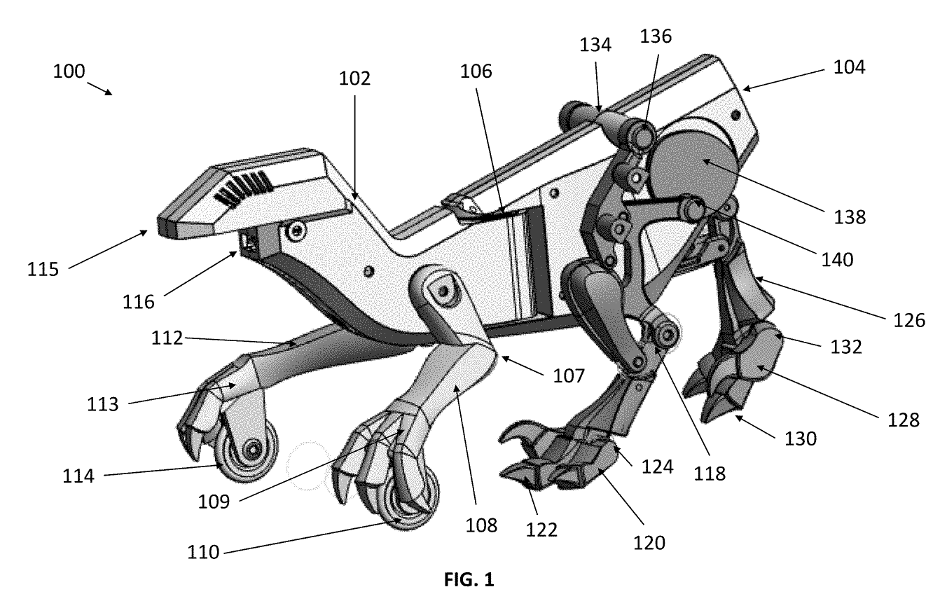

FIG. 1 illustrates a 3D robotic dinosaur 100 with locomotive capability configured to simulate the appearance and movement of a velociraptor according to some embodiments of the disclosed subject matter. The robotic dinosaur 100 includes, among others, a robot head 115, a frontal body 102, a middle body 106, and a rear body 104. FIG. 1 illustrates the left side view of the 3D robotic dinosaur 100. FIG. 1 shows that one end of the frontal body 102 is connected to the robot head 115, and the other end of the frontal body 102 is attached to a middle body 106. The middle body 106 is sandwiched between the frontal body 102 and the rear body 104. In some embodiments, one end of the middle body 106 that is opposite to the end that connects to the frontal body 102 is connected to the rear body 104. In some embodiments, the rear body 104 is pivotally connected to the middle body 106. In some embodiments, a right robotic leg 126 connected to the right side of the rear body 104, and a left robotic leg 118 connected to the left side of the rear body 104.

In some embodiments, the frontal body 102 has a curved portion that generally resembles the neck of a velociraptor and a chest portion that resembles a velociraptor's chest. On top of the neck portion, the robot head 115 is mounted. In some embodiments, the robot head 115 resembles the head of a velociraptor. In some embodiments, below the robot head 115 there is a throat opening 116. In some embodiment the throat opening 116 is embedded into the frontal body 102. In other embodiments, the throat opening 116 is a separately detachable component.

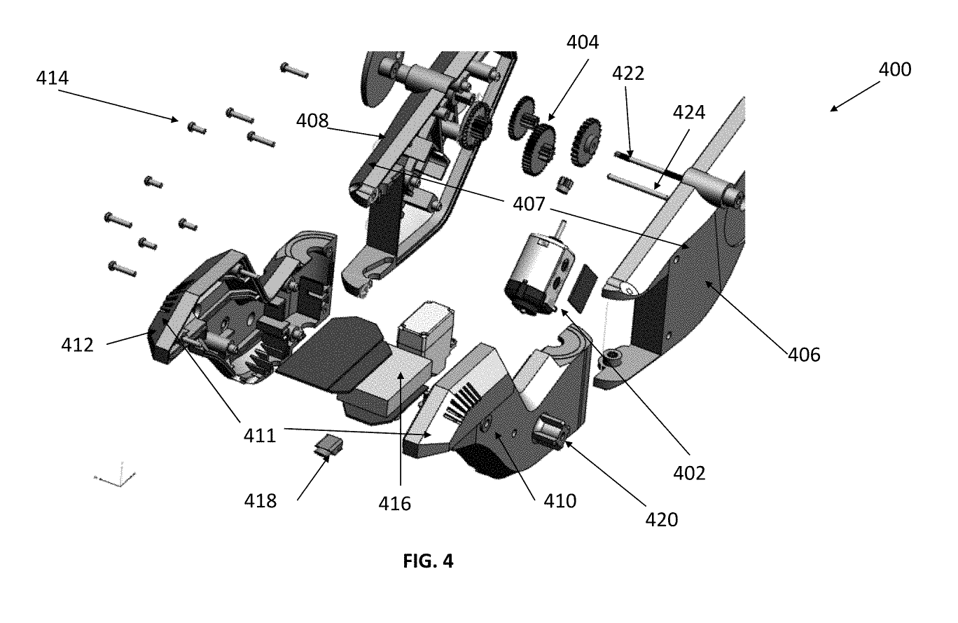

The robot head 115 can be made of the same material as the frontal body 102 or of a different material. In some embodiments, the robot head 115 can be molded into the same module as the frontal body 102. An example of such configuration is shown below in FIG. 4. In other embodiments, the robot head 115 can be a separate module. Furthermore, in some embodiments the robot head 115 is detachable from the frontal body 102. In some embodiments, the robot head 115 can be used to house different components such as motors, sensors, lights, recording devices, and/or various actuators. In some embodiments, the robot head 115 has an actuator that can cause the robot head 115 to turn. In some embodiments, the robot head 115 has an optical sensor to determine the robot's distance from an object to prevent collision.

The throat opening 116 can be used to house various sensors and/or actuators. In some embodiment the throat opening 116 can house an optical sensor to determine the robot's distance from an object to prevent collision. In some embodiments, the throat opening 116 can house a video recording device to capture videos from the robot's view point while the robot is in motion. In some embodiments, the throat opening 116 can house a camera to capture pictures from the robot's view point while the robot is in motion.

Referring to FIG. 1, according to certain embodiments, the chest portion of the frontal body 102 has a right-hand side and a left-hand side. As depicted in FIG. 1, a right arm 112 is pivotally secured to the right-hand side of the chest portion of the frontal body 102. And a left arm 108 is pivotally secured to the left-hand side of the chest portion of the frontal body 102. The arms can also be secured to other portions of the frontal body. For example, in some embodiments, the arms can be attached to the bottom side of the frontal body 102.

Various approaches can be used to secure the arms. As a non-limiting example, buckle tabs, snap clasp, and screws are all suitable fastening approaches. Depending on the fastening method, the attached arms 108 and 112 may have different range of motions. For example, a cylindrical shaped connector may allow the arms to rotate up and down, parallel to the side plane of the frontal body 102. But if a socket ball connector is used, the robot arms 108 and 112 may be able to flap perpendicular to the side plane of the frontal body 102 like chicken wings.

According to certain embodiments, the proximal end of the left arm 108 is connected to the chest portion of the frontal body, and the distal end of the left arm 108 is connected to a claw 109, and a wheel 110. In some embodiments, the arm is extended forward and down with the wheel 110 contacting the ground. In some embodiments, the arm is bend at the elbow 107. In some embodiments, the elbow is a flexible joint that allows the forearm to rotate with respect to the upper arm. In some embodiments, the elbow is a fixed joint. In some embodiments, the wheel 110 is secured to the claw 109 in such a way that the wheel 110 can roll forward and backward. In some embodiments, the wheel 110 is secured to the claw 109 in such a way that the wheel 110 can rotate about the claw 109.

According to certain embodiments, the proximal end of the right arm 112 is connected to the chest portion of the frontal body, and the distal end of the right arm 112 is connected to a claw 113, and with a wheel 114. As shown in FIG. 1, in some embodiments, the left arm 108's configuration is a mirror image of the right arm 112's configuration. In some embodiments, the left arm 108's configuration can be different from the right arm 112's configuration.

In FIG. 1, the distal end of the left arm 108 and the distal end of the right arm 112 are separated at a distance larger than the bottom side of the frontal body 102 measured from the left-hand side to the right-hand side. And the wheels 110 and 114 are aligned on a straight line perpendicular to the centerline of the robotic dinosaur 100, which runs from the head portion of the robot to the hip portion of the robot. In some embodiments, the distal ends of the arms are separated at a distance small than the bottom side of the frontal body 102 measured from the left-hand side to the right-hand side. In some embodiments, the distal ends of the arms 112 and 108 are not aligned on a straight line perpendicular to the centerline. For example, in certain embodiments, the wheel 110 is placed closer to the middle body 106 than the wheel 114.

In some embodiments, the distal ends of the arms 112 and 108 are attached directly to the wheels 114 or 110 without the claws 109 and 113. In some embodiments, the wheels 114 and 110 are replaced with other approaches that can passively help the robot move, such as a roller. In some embodiments, the claws 109 and 113 are attached to breaks that can lock up the wheels 114 and/or 110.

Referring back to FIG. 1, the middle portion 106 is sandwiched between the frontal portion 102 and the rear portion 104. In some embodiments, the middle portion 106 is configured to enable the frontal body 102 to rotate or swing horizontally with respect to the rear body 104. In other embodiments, the middle portion is fixed in place and cannot be rotated. In the embodiments that allows for rotation, the range of rotation can be adjusted. In some embodiments, the rotation is limited to approximately 60 degrees to the left and the right hand side of the robot dinosaur 100. In some embodiments, the degree of rotation is larger than 60 degrees. In some embodiments, the degree of rotation is less than 60 degrees.

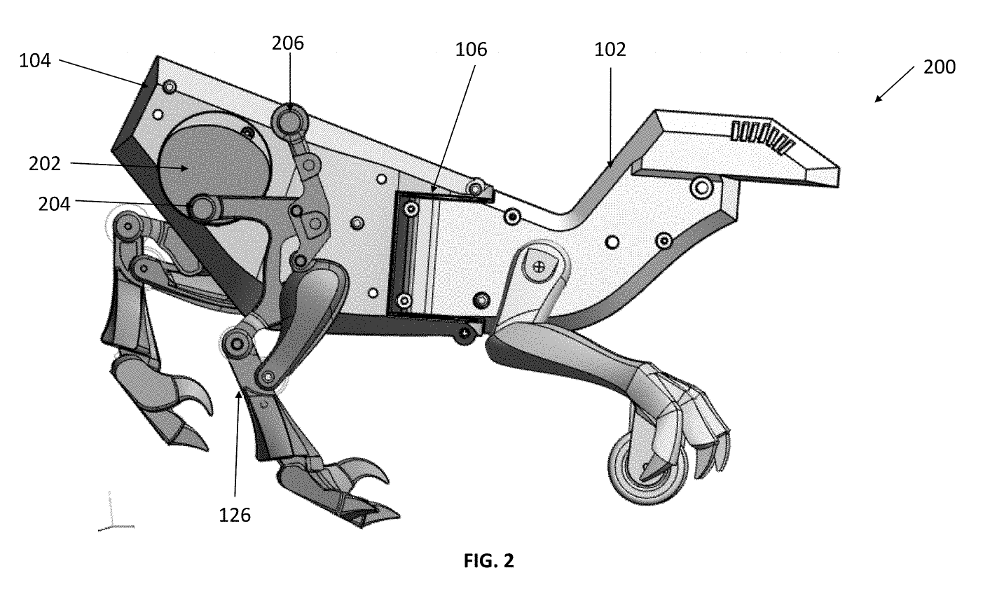

Referring again to FIG. 1, in some embodiments, the rear body 104 connected to the middle body 106 has a horizontal axle 134 with a left axle connector 136 and a right axle connector 206 (shown in FIG. 2), a left rotary backplate 138 with a crank attachment point (not shown) that allows the left leg 118 to connect to the left crank 140, a right rotary backplate 202 (shown in FIG. 2) with a crank attachment point (now shown) that allows the right leg 126 to connect the right crank 204. In FIG. 1, the left leg 118 is connected to the left side of the rear body 104, and the right leg 126 is connected to the right side of the rear body 104. The rear body 104 resembles the hip portion of a velociraptor. In some embodiments, the bottom portion of the rear body 104 is narrower than the top portion such that when viewing the robot dinosaur 110 from the back, the rear body 104 has a “V” shaped curve. The “V” shaped curve allows the distal ends of the legs 118 and 126 to be closer to the centerline of the robot body.

In FIG. 1, the proximal ends of the left leg 118 is pivotally connected to the rear body 104 via the left axle connector 136 and the crank 140. The left leg 118 is constructed by four interconnected linkages. And the distal end of the left leg 118 is connected to a left foot 120 that has left toes 122 and the left heel 124. In some embodiments, the left leg 118 is connected to the rear body with just one connecting point. In some embodiments, more than two connecting points are used. In some embodiments the left foot 120 is fixed to the distal end of the left leg 118 such that the foot does not rotate during the movement. In some embodiments, the left foot 120 is pivotally secured to the distal end of the left leg 118 such that the foot can change its orientation with respect to the leg when the robot dinosaur 100 is in motion.

Although not readily visible from FIG. 1, the right leg 126 is connected to the right side of the rear body 104 in the same way as the left leg 118 is connected to the left side of the rear body. And similar to the left leg 118, the right leg 126 is also constructed by four interconnected linkages. The distal end of the right leg 126 is connected to a right foot 128 that has right toes 130 and the right heel 132. In some embodiments the right foot 128 is fixed to the distal end of the right leg 126 such that the foot does not rotate during the movement. In some embodiments, the right foot 128 is pivotally secured to the distal end of the right leg 126 such that the foot can change its orientation with respect to the leg when the robot dinosaur 100 is in motion.

In some embodiments, the robotic dinosaur 100 may include additional components, fewer components, or any other suitable combination of components that perform any suitable operation or combination of operations

FIG. 2 shows the left side view of the robotic dinosaur 200. The same numbering represents the same component in FIG. 1. FIG. 2 illustrates how the right leg 126 is connected to the right side of the rear body 104. Similar to the connection of the left leg 118, the proximal ends of the right leg 126 is pivotally connected to the rear body 104 via the right axle connector 206 and the crank 204. The crank 204, which is connected to the right leg 126, is fixed to the surface of the right rotary backplate 202. In some embodiments, the right leg 126 is connected to the rear body with just one connecting point. In some embodiments, more than two connecting points are used.

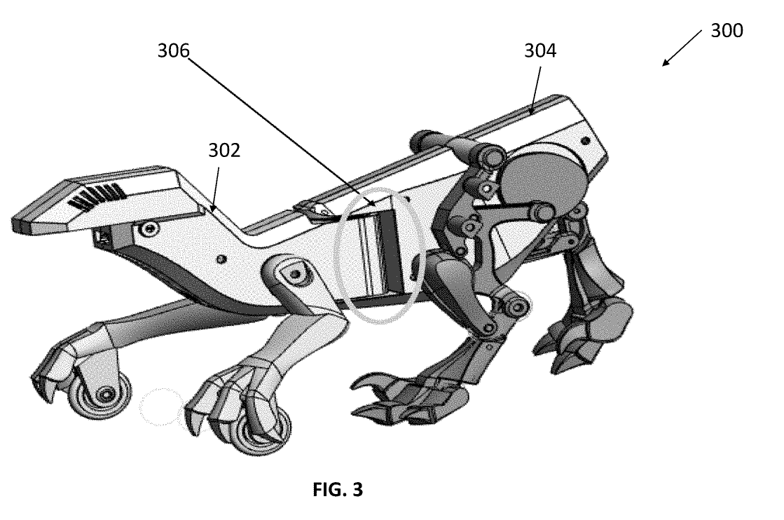

FIG. 3 illustrates the middle body 306 of the robotic dinosaur 300 according to certain embodiments of the present disclosure. In some embodiments, the middle body 306 is a point of rotation that includes a vertical axle and a servo motor to enable the frontal body 302 to rotate and/or swing horizontally with respect to the rear body 304. In some embodiments, the middle body 306 only has a vertical axle, but not a servo motor. In some embodiments, the vertical axle is enclosed in the middle body 306. In some embodiments, the vertical axle is exposed. The vertical axle can take on various shapes such as a cylindrical rode or a rode with multiple discreet faces around the cylindrical surface. The cylindrical rode shape allows a smoother rotation while the rode with multiple discreet faces allows for more controlled rotation. In some embodiments, the range of rotation can be changed by replacing different vertical axles.

FIG. 4 illustrates a robotic dinosaur 400 in an exploded diagram according to certain embodiments of the present disclosure. FIG. 4 shows that the frontal body has an outer shell 411 composed of a right frontal module 412 and a left frontal module 410. In between the two frontal modules, there is a servo motor 402, a core component 416, and a device component 418. On the outer surface of the left frontal module 410 there is an arm connector 420. Likewise, the outer surface of the right frontal module 412 also has an arm connector (now shown). As for the rear body, FIG. 4 illustrates that it has an outer shell 407 composed of a right rear module 408 and a left rear module 406. In between the two rear modules, there is a gearbox 404, a horizonal axle 422, and a rotary motor output 424. According to some embodiments, a plurality of screws 414 are used to attach the right frontal module 412 to the left frontal module 410, and to attach the right rear module 408 to the left rear module 406. In some embodiments, the screws 414 are also used to secure the components within the modules. Various means can be used in place of the screws 414; for example, buckle tabs, snap clasp, and any other feasible fastening approach.

In some embodiments, the frontal body is assembled by placing the inner components (the servo motor 402, the core component 416, and/or the device component 418) in their respective groves, in between the modules, and then snap the modules together. In some embodiments, the screws 414 are used to attach the modules.

In some embodiments, the servo motor 402 with a power output is connected to the gearbox 404. In some embodiments, the gearbox 404 has multiple circular gears arranged in a configuration responsive to the servo motor 402. In some embodiments, the rotary motor output 424 is connected to at least one of the circular gears in the gearbox 404, so that when the servo motor 402 is activated the rotary motor output 424 would rotate either clockwise or counterclockwise.

Referring to FIG. 1 and FIG. 2, in some embodiments, one end of the rotary motor output 424 is connected to the right leg 126 via the right rotary backplate 202, and the other end of the rotary motor output 424 is connected to the left leg 118 via the left rotary backplate 138. When the servo motor 402 is activated, the rotation of the rotary motor output 424 will cause the right rotary backplate 202 and the left rotary backplate 138 to move in a circular motion, either clockwise or counterclockwise. The movement of the rotary backplates will cause the right leg 126 and the left leg 118 to step forward or backward, and thus set the robotic dinosaur 100 in motion.

The servo motor 402 can be battery powered, fuel powered, solar powered, or mechanically powered by a windup mechanism. Moreover, other suitable actuator capable of a rotational output, such as a DC motor or a coil drive motor can also be used in placed of the servo motor 402.

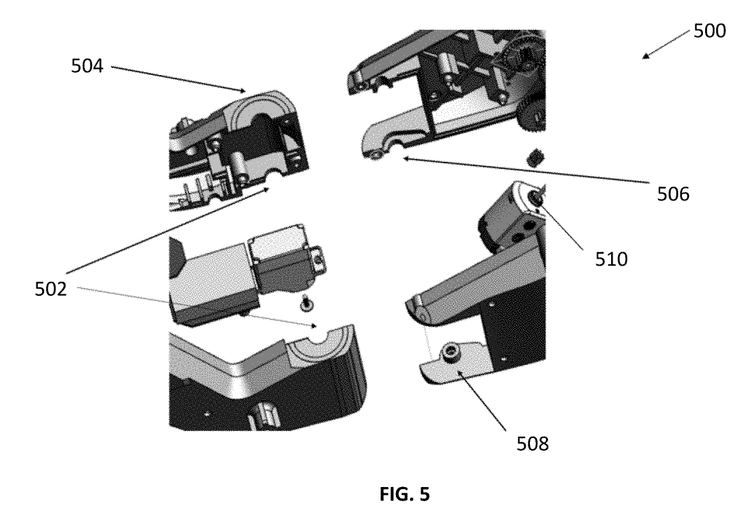

FIG. 5 illustrates an exploded view of the robotic dinosaur 500 according to certain embodiments of the present disclosure. FIG. 5 shows that the servo motor 510 is housed within the servo capture 502. The servo capture 502 is formed by an inner capture portion 504 and an outer capturing portion 506. In some embodiments, the inner capture portion 504 is a part of the frontal body that connects to the middle body. In some embodiments, the outer capturing portion 506 is a part of the rear body that connects to the middle body. A servo “horn” spline 508 sits at the bottom of the servo capture 502. In some embodiments, a part of the servo “horn” spline 508 connects the frontal body to the rear body. In some embodiments, the servo capture 502 and the servo “horn” spline 508 are a part of the middle body.

In some embodiments, the servo motor 510 is connected to the servo “horn” spline 508. When the servo motor 510 is activated, the servo motor 510 can cause the servo “horn” spline to adjust its position and thus indirectly causes the frontal body to rotate. In some embodiments, the servo motor 510 is connected to other parts of the frontal body via a gear (not shown). In such embodiments, when the servo motor 510 is activated, the frontal body can be rotated in response to the gear's rotation.

### Leg Mechanism

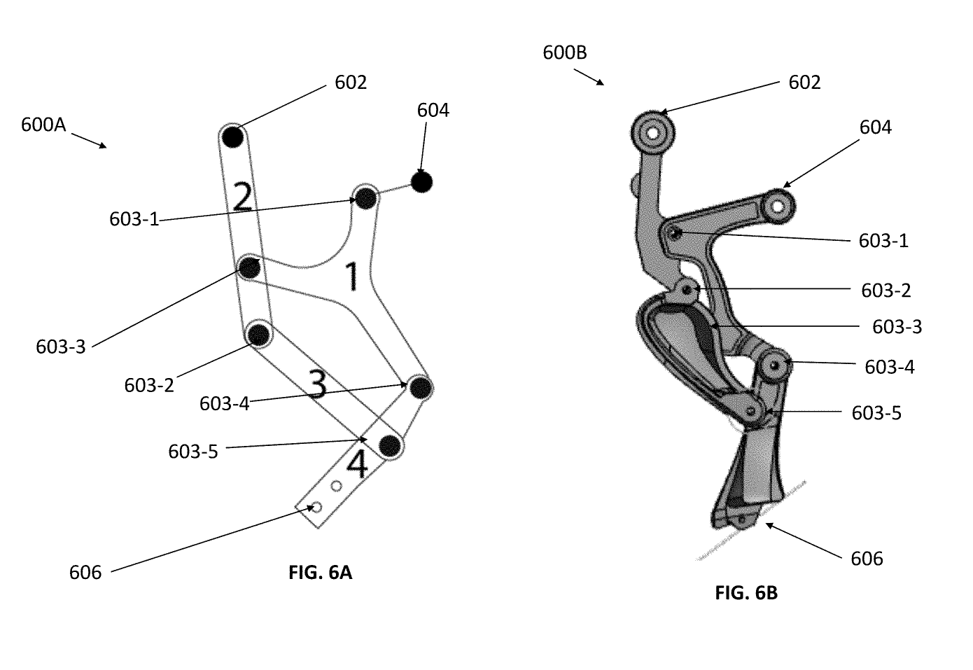

FIG. 6A shows a linkage assembly diagram 600A according to according to certain embodiments of the present disclosure. Linkage assembly diagram 600A illustrates how four kinematic linkages are connected to form a robotic leg according to certain embodiments. The kinematic linkage 1 has a rotational point 603-1 connected to a fixed point 604. Linkage 1 is connected to linkage 2 via rotational point 603-3, and to linkage 4 via rotational point 603-4. The kinematic linkage 2 has a fixed point 602. The kinematic linkage 2 is connected to linkage 1 via rotational point 603-3, and to linkage 3 via rotational point 603-2. The kinematic linkage 3 is connected to linkage 2 via rotational point 603-2, and to linkage 4 via rotational point 603-5. The kinematic linkage 4 is connected to linkage 1 via rotational point 603-4, and to linkage 3 via rotational point 603-5. In addition, the kinematic linkage 4 has a rotational point 606 at one end of the linkage opposite to the rotational point 603-4. The rotational point 606 is configured to connect to other linkages or suitable modular components. The fixed points are connection joints where the linkages do not rotate around. The rotational points are connecting joints where the linkages can rotate around when the robotic leg is in motion. In some embodiments, a robotic leg is constructed by more than 4 kinematic linkages. In some embodiments, a robotic leg is constructed by less than 4 kinematic linkages.

FIG. 6B illustrates a prototype of robotic leg assembly 600B according to certain embodiments of the present disclosure. The numbers on the robotic leg 600B represent the same rotational and fixed points illustrated in FIG. 6A. Referring to FIG. 2, in some embodiments, the fixed point 604 is attached to the crank 204. And the fixed point 602 is connected to the right axle connecter 206 of the horizonal axle 134 in FIG. 1. In some embodiments, the rotational point 606 is connected to a foot.

In some embodiments, the robotic legs are constructed with safety features to prevent finger entrapment. If the linkages are connected by regular mechanical hinge, multiple scissor points in between kinematic linkages can be dangerous for the operators. The scissor points are gaps in the leg assembly between linkages that open and close as the mechanism rotates. In some embodiments, one or more sliding backplates are used to remove the scissor points.

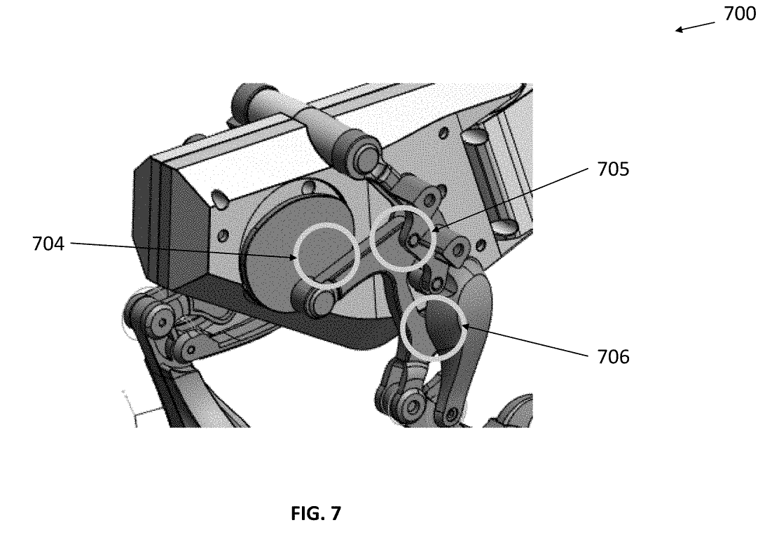

FIG. 7 illustrates different sliding backplate mechanisms for covering or replacing the scissor points according to certain embodiments of the present disclosure. The robot dinosaur 700 has several sliding backplate mechanisms that covers one or more rotational or fixed points. For instance, the backplate mechanism 704 allows the link 1 of the robotic leg to glide over the surface of a rotary backplate. The backplate mechanism 705 allows linkage 1 to slide under linkage 2 when the leg is in motion. The backplate mechanism 706 allows linkage 1 to slide under linkage 3 when the leg is in motion.

The mechanism of the sliding backplate connections can prevent the operator, often a child, from accidentally trapping/pinching his or her finger in between the moving kinematic linkages. In operation, the sliding backplate mechanism would allow the linkage on top to glide over the linkage at the bottom, and thus remove the scissor points from the mechanism.

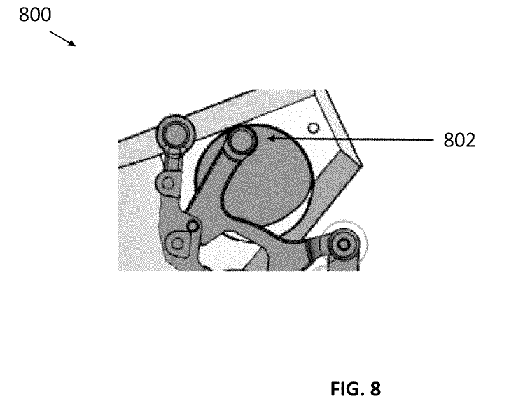

FIG. 8 illustrates a two-dimensional view of a sliding backplate mechanism constructed by a rotary backplate and a crank. In some embodiments, a proximal end of the robotic leg is pivotally connected to the rear body via the crank attachment point 802. In some embodiments, the crank attachment point 802 is the connecting point underneath the crank. A comparison of FIG. 8 to FIG. 7 demonstrates how a linkage of the robotic leg glides over the rotary plate. As shown by FIG. 8, when the crank is at the top of the rotation, more linkage surface area is covering the backplate. As the crank is moved towards the bottom of the rotation, less linkage surface area is covering the backplane.

### Foot Mechanism

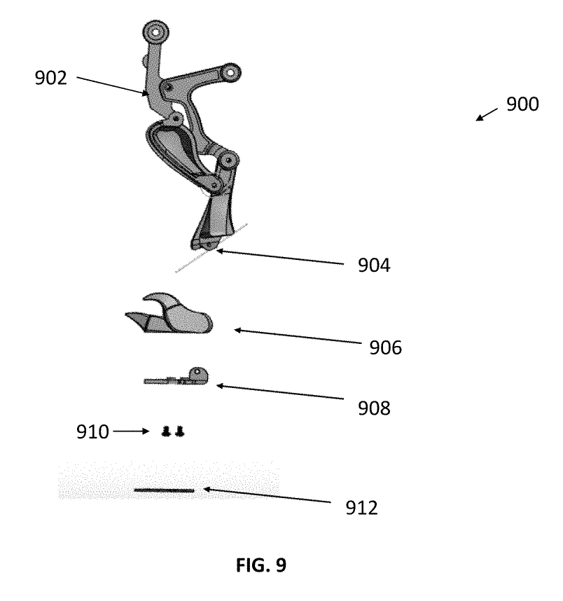

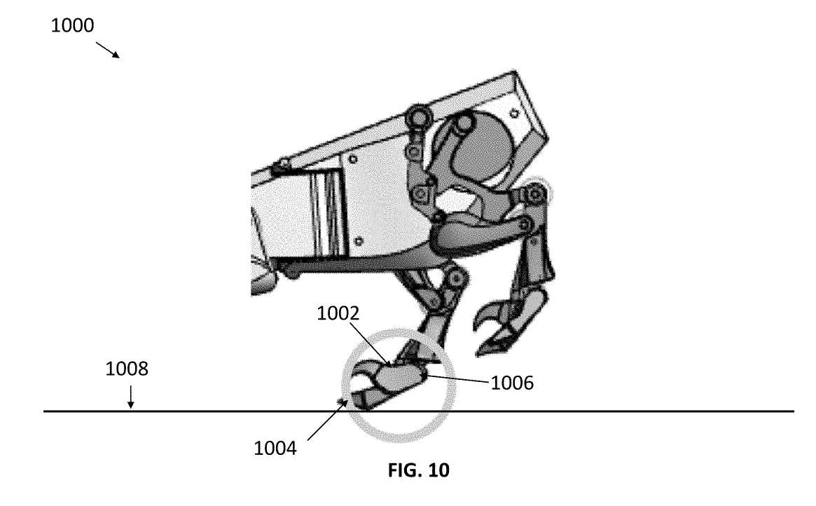

FIG. 9 illustrates an exploded view of the foot mechanism 900 according to certain embodiments of the present disclosure. FIG. 9 shows that the foot rotation point 904 is at the distal end of the robotic leg 902. The foot rotation point 904 has a drill hole that allows the spring mechanism 910 to penetrate. In some embodiments, the foot 906 is connected to the leg 902 via the foot rotation point 904. According to some embodiments, the connection involves attaching the foot pad grip insert 912 to the bottom of the foot insert 908, inserting the modified foot insert 908 into the foot 906, then securing the foot assembly to the foot rotation point 904 by the spring mechanism 910. In some embodiments, the inserting step is done by pushing the modified foot insert into an opening in the center of the foot 906 (not shown). In some embodiments the spring mechanism is naturally biased towards the ground. For example, when the leg is in the air, the spring mechanism will naturally push the foot assembly to a toe-down position. An exemplary view of the toe-down position is shown in FIG. 10.

FIG. 10 shows a toe-down position of the foot as the foot touches the ground according to certain embodiments of the present disclosure. FIG. 10 illustrates the robot dinosaur 1000's relative position to the ground 1008 as the toe 1004 of the right foot 1002 touches the ground 1008. As the robot dinosaur 1000 moves forward, the heel 1006 will gradually descend to the ground and finally make a contact with the ground 1008. Then as the rotation continues, the foot 1002 will stay flat on the ground for a brief period of time until the rotation lifts the foot 1002 off the ground 1008 again. When the foot 1002 is in the air, the foot 1002 will resume its toe-down position again.

There are several advantages associated with this design. The toe-down position helps the robot create better contacts with the ground and gain better tractions. It addition, it can also provide more forward momentum. By having the spring mechanisms “push off” the ground each time the foot contacts the ground, additional momentum is generated. Appearance wise, the toe-down position provides more lifelike appearance for the robotic when the leg is in the air.

### Pseudo-Bipedal Motion

The present disclosure implemented various mechanisms to help a bipedal-driven robot achieve stability even at a running speed. And in some embodiments, the robot is configured maintain its stability even when a miss step occurs.

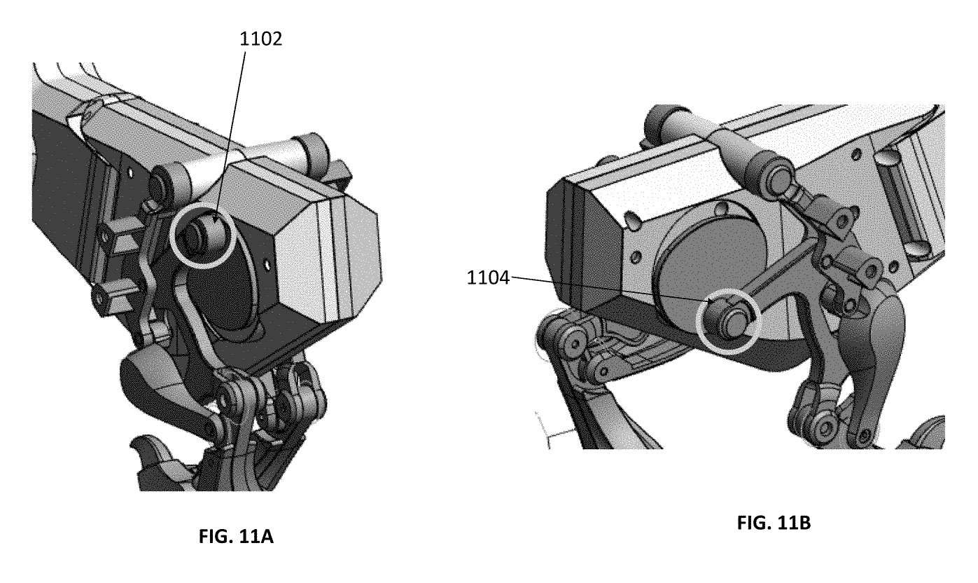

FIGS. 11A and 11B illustrate the bipedal rotation mechanism according to certain embodiments of the present disclosure. In FIG. 11A, the left leg is attached to the crank 1102. And the crank 1102 has circled to the top of the rotation (top dead center). In FIG. 11B, the right leg is attached to the crank 1104. And the crank 1104 has circled to the bottom of the rotation (bottom dead center). The crank 1102 and the crank 1104 exhibit a 180-degree out of phase positioning relationship. In both 11A and 11B, the legs are fixed to the drive shaft at their relative positions. When the robot is in motion, their relative positions will remain fixed. For example, when the crank 1102 is at the top of the rotation, the crank 1104 will be at the bottom of its rotation. And when the crank 1104 is at the top of the rotation, the crank 1102 will be at the bottom of its rotation. When the robot is in motion, the two opposing cranks will continue to rotate 180 degrees out of phase, so that the robot is being propelled one step at a time. Because of the 180 degrees out of phase relationship, the robotic dinosaur is able to simulate the bipedal movement of the velociraptor.

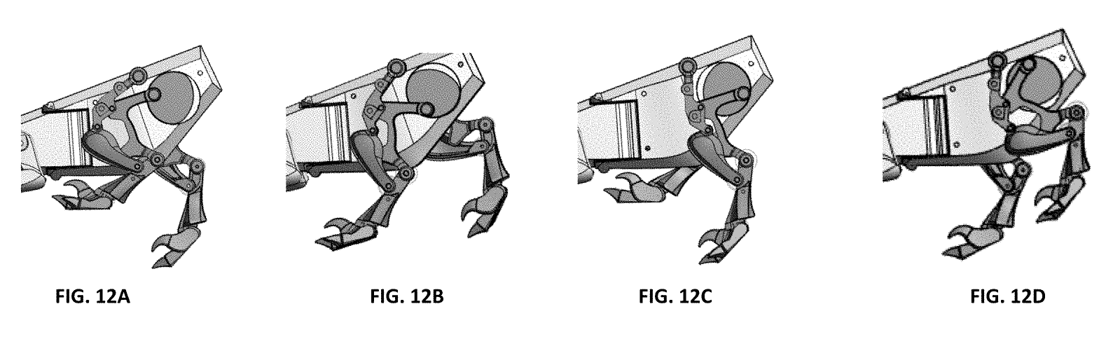

FIGS. 12A-12D illustrate a sequence of motions as the robot travels over a surface according to certain embodiments of the present disclosure. FIG. 12A depicts a snapshot of a walking or running motion where the right foot is about to be rotated off the ground as the left foot is rotating towards the ground. FIG. 12B depicts a snapshot of the walking or running motion where the right foot just left the ground and the left foot just touched the ground. FIG. 12C depicts a snapshot of the walking or running motion where the left foot is about to leave the ground and the right foot is rotating towards the ground. Finally, FIG. 12D depicts a snapshot of the walking or running motion where the right foot is touching the ground, and the left foot is rotating off the ground. In some embodiments, when the robot is in motion, the legs will go through the four movements depicted by FIGS. 12A-D repeatedly.

Referring back to FIG. 1, in some embodiments, in operation, the robotic dinosaur 100 does not move with a true bipedal motion. Rather, it acts as an inverted tricycle system. To increase the stability of the robot in motion, in some embodiments, the bottom portion of the rear body 103 is narrower than the top portion so that the legs 118 and 126 can have room to extend closer to the centerline of the robot body. In some embodiments, the design of the lower shin and foot also puts the ground contacting point of the feet 120 and 128 closer to the centerline of the robot body. And in some embodiments, the arms are weighted so that the center of gravity is shifted closer to the frontal body 102.

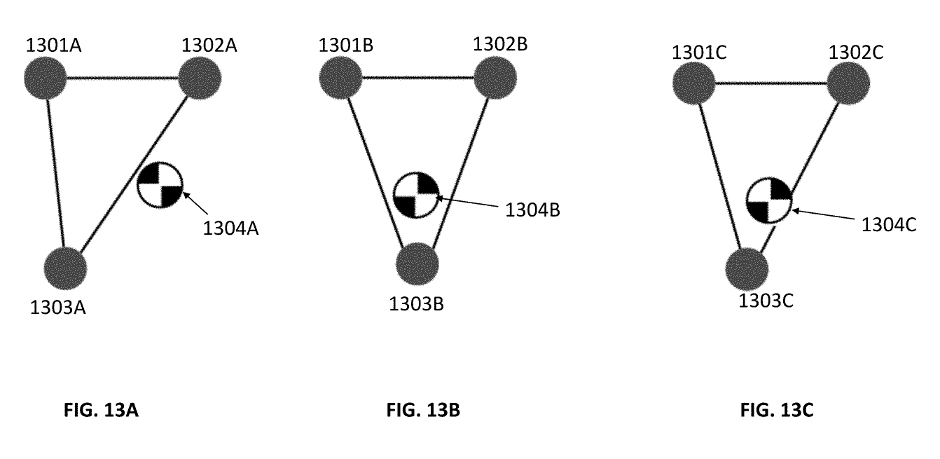

FIGS. 13A-13C illustrate the stability profile of the robot according to certain embodiments of the present disclosure. Viewing FIG. 13C in light of FIG. 1, in some embodiments, the point 1301C represents the ground contacting point of the left wheel 110. The point 1302C represents the ground contacting point of the right wheel 114. The point 1303C represents the ground contacting point of a foot as it contacts the ground. In some embodiments, 1301C, 1302C and 1303C form a triangular alignment that supports the weight of the dinosaur robot 100. And the checker circle 1304C represents the robot dinosaur 100's center of gravity. FIGS. 13A and 13B are similar to FIG. 13C. FIG. 13A illustrate a stability profile that likely to cause the robot to fall because the center of gravity 1304 falls outside of the triangle alignment formed by 1301A, 1302A, and 1303A. FIG. 13B illustrates a stability profile that is ideal for keeping the robot upright when the robot is not moving.

The stability of the robot is analyzed using a quasi-static analysis shown in FIGS. 13A-13C. Referring to FIGS. 13A-C, if there are always three points of contact with the ground, the center of gravity (e.g., the checker circle 1304B) would often lie within the triangle formed by these three points (e.g., 1301B, 1302B, and 1303B). FIG. 13B demonstrates the more stable scenario where the ground contacting point 1303B creates an isosceles triangle with the two frontal limbs 1301B and 1302B. In this scenario, the center of gravity 1304B is well within the triangular alignment so that the robot is not likely to fall. FIG. 13A illustrates a scenario where the foot contacts the ground further way from the body such that when the foot presses on the ground the triangular alignment is shifted to the left side of the robot. In this scenario, the center of gravity 1304A is outside of the triangular alignment, and the robot is likely to fall towards the side between points 1302A and 1303A. FIG. 13C illustrates a triangular alignment achieved by the present invention according to certain embodiments of the present disclosure. In operation, because the legs are positioned to the sides of the body, the robot does not operate under the ideal scenario depicted by FIG. 13B. However, according to certain embodiments of the invention, the robot legs are designed to be bias towards the center of the robot body such that when a foot contacts the ground, the contact point 1303C will be closer to the alignment depicted in FIG. 13B rather than the alignment depicted in FIG. 13A.

Various features have been implemented to help maintain the center of gravity 1304C within the triangular alignment. One way to aid the stability is by adding weights to the frontal limbs. In some embodiments, the weight can be added by using heavier modeling materials. Heavier frontal limbs would cause the center of gravity to shift forward, where the triangular alignment is wider, and thus improves the stability. Another feature is the three-dimensional (3D) shape of the linkage design. During each step of the bipedal motion, the center of the gravity of the robot shifts left or right. As illustrated in FIG. 13A, if the legs are positioned too far from the centerline (by wider hips or body for example), the stability is likely to be poor. The triangular alignment is likely to be slanted away from the ideal isosceles triangle shape. Hence, in some embodiments, the 3D shape of the linkage bends inwards underneath the body. The bending of the linkage mechanism brings the contact point of each foot closer to the centerline, and thus increases the overall stability.

In some embodiments, one or more sensors are implemented to help the robot to maintain its balance. For example, as the robot moves forward or backward, an onboard accelerometer sensor can detect a fall early enough for the robot to take a corrective action. In some embodiments, the corrective action includes actively steering the frontal body of the robot to regain balance. For instance, by pivoting the frontal limbs left or right, the robot can ‘catch’ a fall, much like a bicyclist can catch a fall by turning into the fall direction.

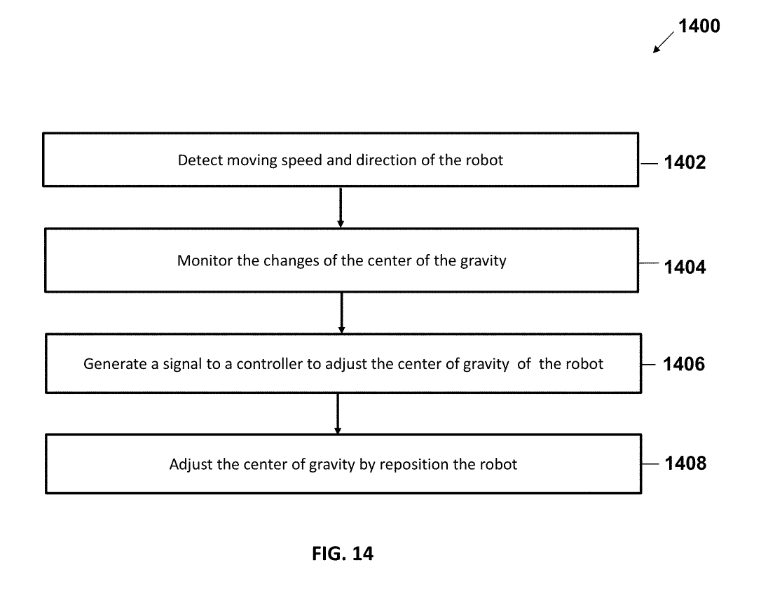

FIG. 14 is a flow chart illustrating a process 1400 of maintaining stability while moving in a bipedal fashion. The process 1400 is illustrated in connection with the robotic dinosaur 100 shown in FIG. 1. In some embodiments, the process 1400 can be modified by, for example, having steps rearranged, changed, added, and/or removed.

At step 1402, an onboard sensor or accelerometer detects the robotic dinosaur 100's moving speed. In some embodiments, the detection is based a sensor's determination of positional changes over time. In some embodiments, the detection is based on the rotational speed of the gears and/or motor. In some embodiments, other suitable sensors can be used. The process 1400 then proceeds to step 1404.

At step 1404, a sensor monitors the change of the center of gravity as the robotic dinosaur 100 moves one step to another. The area of monitoring can be limited to just the rear body 104 or to include the whole robotic dinosaur 100. In some embodiments, the changes are monitored by a level sensor where both the degree of the body tilt (to the left or to the right), and the frequency of the body tilt are monitored. In some embodiments, the changes are monitored by one or more pressures sensors attached to the feet 120 and 128. In some embodiments, the sensor or sensors used at step 1404 can the same sensor or sensors used at step 1402. The process 1400 then proceeds to step 1406.

At step 1406, a signal is generated to a controller such as an onboard motor. In some embodiments, the signal is communicated through an internal circuit. In some embodiments, the signal is wirelessly transmitted. In some embodiments, the signal instructs the control component about the action to take. In some embodiments, the control component analyzes the received signal then determine an appropriate action to take. The process 1400 then proceeds to step 1408.

At step 1408, if the instability is detected, the controller would cause the robotic dinosaur 100 to take appropriate corrective actions. In some embodiments, the onboard motor would instruct the frontal body 102 to pivot towards the direction of instability. For example, if the robot dinosaur 100 is about to fall to the right, the onboard motor would rotate the frontal body to the left to balance and prevent the fall. In some embodiments, the onboard motor would speed up the rotation so that the other foot can rotate to the ground faster to reposition the robot.

Referring again to FIG. 1, in some embodiments, the robotic dinosaur 100 operates autonomously. The robot can be put in motion with an on-and-off switch. In some embodiments, the robotic dinosaur 100 is responsive to wireless commands, and can operate as a remote-controlled toy. In some embodiments, the modules and linkages of the robotic dinosaur 100 are made of the same material, for example, plastics of various strength, fiberglass, light weight metals, and/or any other suitable materials. In some embodiments, different parts of the robotic dinosaur 100 are made of different materials. For example, to sustain wear and tear, foot 120 and 128 may be made of a light weight metal while the rest of the body is made of plastic.

While the description may refer to certain embodiments as a “robotic toy,” “toy robot,” “robot toy,” “robot,” “toy,” “toy dinosaur,” “robotic dinosaur,” and “robot dinosaur,” etc. These terms are merely exemplary ways to refer to certain embodiments of the present invention. These terms do not limit the present invention to a particular use or category of use. Moreover, although certain embodiments of the present invention are described according to a two-legged dinosaur that looks like a velociraptor, it is understood that other designs are also within the scope of the invention.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A robot with locomotive capability, comprising:
a frontal body;
a rear body;
a middle body (1) having a first end coupled to the frontal body, (2) having a second end that is opposite to the first end of the middle body and coupled to the rear body, and (3) configured to cause the frontal body to rotate with respect to the rear body;
a first frontal limb pivotally secured to the frontal body and having a first distal end;
a second frontal limb pivotally secured to the frontal body and having a second distal end;
a first leg pivotally secured to a first side of the rear body and having a third distal end;
a first foot pivotally secured to the third distal end;
a second leg pivotally secured to a second side of the rear body and having a fourth distal end, wherein the second side of the rear body is opposite to the first side of the rear body; and
a second foot pivotally secured to the fourth distal end,
wherein the first distal end of the first frontal limb, the second distal end of the second frontal limb, and either the first foot or the second foot are configured to support the robot by forming a triangular alignment encompassing a center of mass of the robot as the first leg and the second leg alternately move between a forward position and a rearward position.

2. The robot of claim 1, further comprising a motor disposed in the rear body, configured to alternately move the first leg and the second leg between the forward position and the rearward position.

3. The robot of claim 2, wherein the first leg is pivotally secured to a first output of the motor via a first connector, and the second leg is pivotally secured to a second output of the motor via a second connector;
wherein the first output rotates the first connector in such a way that causes the first leg to move between the forward position and the rearward position; and
wherein the second output rotates the second connector in such a way that causes the second leg to move between the forward position and the rearward position.

4. The robot of claim 3, wherein the first output and the second output are 180 degrees off-phase such that when the first leg is moving towards the forward position, the second leg is moving towards the rearward position.

5. The robot of claim 1, wherein the first leg and the second leg are biased towards a center of the triangular alignment as the first leg and the second leg alternately move between the forward position and the rearward position.

6. The robot of claim 1, further comprises a wheel secured to at least one of the first frontal limb and the second frontal limb.

7. The robot of claim 1, wherein the middle body further comprises a vertical rotational axle.

8. The robot of claim 7, further comprising a motor for moving the vertical rotational axle as the first leg and the second leg alternately move between the forward position and the rearward position.

9. The robot of claim 1, wherein the first foot is pivotally secured via a spring to the third distal end; wherein the spring allows the first foot to change its orientation with respect to the rear body as the first leg moves between the forward and the rearward position.

10. The robot of claim 1, wherein the second foot is pivotally secured via a spring to the fourth distal end; wherein the spring allows the second foot to change its orientation with respect to the rear body as the second leg moves between the forward position and the rearward position.

11. The robot of claim 1, wherein at least one of the first and the second leg comprises four interconnected links.

12. The robot of claim 11, wherein at least two of the four interconnected links are connected by a sliding backplate.

13. The robot of claim 2, wherein at least one of the first and the second leg further comprises:
a first link pivotally secured to the motor, a second link, and a fourth link;
the second link pivotally secured to a fixed point on the rear body, the first link, and a third link;
a third link pivotally secured to the second link and the fourth link; and
the fourth link pivotally secured to the first link and the third link.

14. The robot of 13, wherein at least one of the first link, the second link, the third link, and the fourth link is pivotally secured via a sliding backplate.
